(19) United States
(12) Patent Application Publication
(10) Pub. No.: US 2007/0007285 A1
(43) Pub. Date: Jan. 11, 2007

(54) Energy delivery method and apparatus using volume conduction for medical applications

(76) Inventors: Mingui Sun, Pittsburgh, PA (US); Robert Joseph Sclabassi, Gibsonia, PA (US); Daliang Leon Li, Pittsburgh, PA (US)

Correspondence Address: ECKERT SEAMANS CHERIN & MELLOTT, 600 GRANT STREET, 44TH FLOOR, PITTSBURGH, PA, 15219, US

(21) Appl. No.: 11/389,791

(22) Filed: Mar. 27, 2006

Related U.S. Application Data
(60) Provisional application No. 60/667,439, filed on Mar. 31, 2005.

(51) Int. Cl. H05B 6/62

(52) U.S. Cl. 219/772

(57) ABSTRACT

The present invention may be utilized in medical applications requiring the external delivery of electrical energy from outside the human body to a target site within the human body, such as electrical stimulation of muscles and power delivery to implanted devices. The present invention uses the volume conduction property of human tissue as a natural medium for energy delivery. A novel volume conduction antenna consists of an array of electrodes that are structured and arranged to receive voltage and work collaboratively to transmit electrical energy to the target site. A unique voltage is applied to each electrode to direct the electrical energy to the target site. The desired energy density near the target site is optimized, while the undesired energy density near the site of the antenna is minimized.

### CROSS-REFERENCE TO RELATED APPLICATION

This application claims the benefit of U.S. Provisional Patent Application Ser. No. 60/667,439 filed Mar. 31, 2005, entitled: “ENERGY DELIVERY METHOD AND APPARATUS USING VOLUME CONDUCTION FOR MEDICAL APPLICATIONS”.

### STATEMENT OF GOVERNMENT INTEREST

This work was supported in part by the U.S. Army under Contract No. US ARMY SBIR W81XWH-05-C-0047, and the National Institutes of Health under Research Grant No. NIH R01EB002099. The Government may have certain rights in this invention.

### BACKGROUND INFORMATION

In many medical cases, electrical energy must be delivered from the outside of the human body to the inside for a variety of applications. For example, almost all implantable devices require an electrical power source, which is usually a battery. Because the battery inside the implant cannot be replaced easily, it is often designed to be rechargeable using electrical power delivered from the outside of the human body. One commonly used recharging mechanism is based on a transformer consisting of a primary coil and a secondary coil. When a radio frequency (RF) signal is applied to the primary coil, current is induced in the secondary coil. This current can be used as a power supply or for recharging a battery. Although this method has many applications, it has a severe drawback. As the size of the implantable device reduces and the distance between the primary and secondary coils increases, the RF approach becomes unattractive because of the rapid decline in magnetic coupling between the two coils.

Electrical energy may also be delivered from the outside of the human body to the inside to directly stimulate tissue for a variety of medical procedures. For example, during surgery, electrical stimulation may be provided to the motor cortex through electrodes placed on the scalp. Clinical neurophysiologists then monitor the motor evoked potentials and muscle responses elicited by the stimuli. If abnormality is detected, the neurosurgeon is notified immediately to take corrective action and reduce the chance of postoperative neurological defects. In this application, certain cortical sites must receive a sufficient amount of electrical stimulation in order to produce the desired responses reliably. However, a high voltage (as high as 1500 V) is required across a pair of stimulation electrodes. The resulting high power density in the areas adjacent to the electrodes may cause tissue damage.

There are many other medical problems requiring energy delivery. For instance, epileptic seizures may be stopped by delivering electrical pulses to a certain target region within the brain. In rehabilitation, electrical muscle stimulation (EMS) can be used to prevent muscle loss (atrophy) during the recovery process after injury. EMS also has an attractive application in weight loss and muscle/body shape ”toning”. In all of these cases, the design of a device to efficiently deliver electrical energy to the inside of the human body is critical.

Currently, there exist various antenna designs (e.g., U.S. Pat. Nos. 6,076,016, 6,754,472, and 6,847,844). A voltage or current source is applied to a pair of skin-surface electrodes to create an electric field within the human body based on the principle of volume conduction. Energy is produced by the electric field by Joule's Law: P=σE·E, where P,σ, and E are, respectively, the energy density, conductivity, and electric field. In order to increase P at the target location, the voltage or current applied to the pair of electrodes must be increased. However, this increase is limited because, if P is too large at the electrode sites, the thermal energy dissipated near the electrode sites may cause tissue damage due to beating, and a strong electrical current at these sites may trigger undesired stimulation to excitable tissue, such as nerve and muscle cells. The electrode pair antenna has another drawback that it does not have a mechanism to focus energy on the target location and cannot be used to scan a region without physically changing the electrode sites.

### SUMMARY OF THE INVENTION

Many medical applications require delivery of electrical energy from the surface of the human body to a target region within the body for therapeutic, prosthetic, and diagnostic purposes. For example, an implanted medical device may rely on the delivered energy for either normal operation or charging of a battery or other power source; an electronic medical device could be designed to stop a seizure by producing electrical pulses delivered to the epileptic focus within the brain; or medical devices such as deep brain stimulators could deliver electrical pulses to suppress tremors. A second use, besides providing energy to recharge implanted medical devices, is to deliver energy to externally stimulate intracranial regions of the central nervous system. This invention uses the volume conduction property of the human tissue as a natural medium for energy delivery. A novel volume conduction antenna is designed inspired by the sophisticated weaponry system of certain electric fish which deliver electrical energy to stun prey. The new antenna consists of an array of electrodes with graded voltages applied through them in order to optimize the desired energy density in the target region and minimize the undesired energy density near the site of antenna.

It is an object of the present invention to provide an antenna for delivering electrical energy to a target site in a patient's body, the antenna comprising an array of electrodes, wherein the electrodes are structured and arranged to receive voltage and work collaboratively to transmit electrical energy to the target site.

It is another object of the present invention to provide a method for delivering electrical energy to a target site in a patient's body, the method comprising providing an array of electrodes, wherein the electrodes are structured and arranged to receive voltage and work collaboratively to transmit electrical energy to the target site; and delivering a unique voltage to each electrode, wherein the unique voltage activates the transmission of electrical energy from the array of electrodes to the target site.

These and other objects of the present invention will become more readily apparent from the following detailed description and appended claims.

### FIGURES

FIG. 1 presents a graphical representation of potential gradient and current density vectors of the electric eel in water.

FIG. 2 illustrates three examples of antenna designs for electrical energy delivery.

FIG. 3 presents a graphical representation of electric field and current density vectors for a linearly designed antenna.

FIG. 4 provides a comparison of linear source antenna and electrode pair antenna with an equal current emission.

FIG. 5 provides a comparison of electrode pair antenna and a 9-electrode linear source antenna based on equal maximum power dissipation.

FIG. 6 provides a comparison of electrode pair antenna and an 18-electrode linear source antenna based on equal maximum power dissipation.

### DETAILED DESCRIPTION OF THE PREFERRED EMBODIMENTS

As used herein, the term “patient” shall refer to any human or member of the animal kingdom. While the description contained herein primarily refers to humans, it is understood that the apparatus and methods of the present invention are applicable to members of the animal kingdom as well.

The present invention may be utilized for any medical application requiring the external delivery of electrical energy from the outside of the human body to the inside of the human body, such as electrical stimulation and power delivery to implanted devices. The present invention focuses on the power transmission antenna, which is the key component of the electrical energy delivery system. The human body consists of abundant ionic fluids which can be used as a natural medium for passing energy and electrical current. The antenna provides a necessary electrode-electrolyte interface between the external system and the human body.

The antenna design was inspired by the amazing biological structure of electric fish. Evolution over millions of years has produced a highly effective electrical energy delivery system for these aquatic creatures to kill, navigate, and communicate in ionic water, which is physically similar to the human body in terms of volume conduction. For example, the South American electric eel, a strongly electric fish, is capable of discharging 500V (head positive) at a maximum pulse frequency of 25 Hz into its surrounding water through synchronized discharging of voltage generating cells known as electrocytes in its body. Weakly electric fish typically generate less than one volt in amplitude. Although the electric field of weaker fish cannot be used to stun prey, it can be used for navigation, object detection, and communication.

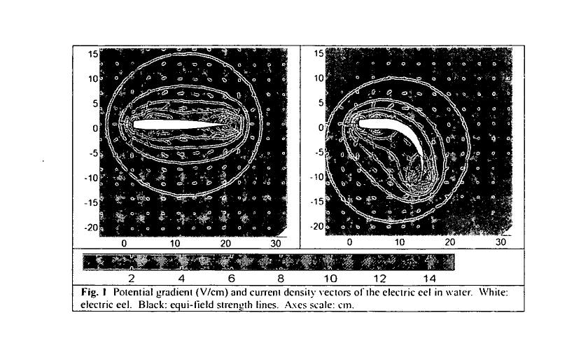

The weaponry organs of the strongly electric fish are arranged in a linear form, rather than the dipolar form as seen in the existing energy delivery antenna designs. Each column of 5,000 to 10,000 electrocytes, connected in series, spans approximately 80% of the electric eel's body. Approximately 70 columns are arranged in parallel on each side. To simulate the discharge of the electric eel using finite element analysis, the electric eel was modeled in a top-down cross section and placed in a cross-section of a large, spherical “fish tank.” The 2-D simulation results are shown in FIG. 1 where black curves represent equal electric fields, color represents the electric field strength, and arrows denote current density vectors whose length is proportional to the electric field strength. It can be observed that tail bending distorts the surrounding electric fields. Larger (smaller) fields are induced in the concave (convex) side. This indicates that the shape of the body helps to redistribute and focus electric energy.

The antenna of the present invention contains an array, rather than a pair, of electrodes. Each electrode may be supplied with a unique voltage value. The voltage delivered to each electrode may be a positive voltage, a negative voltage, or zero voltage. The voltage activates the transmission of responsive electrical energy from the array of electrodes to the target site. The electrodes work collaboratively to direct the electrical energy to the targeted site. The voltage delivered to each electrode is predetermined to control the depth, direction, and/or duration of the electrical energy transmitted from the array of electrodes. In a preferred embodiment, the array of electrodes may be affixed to the skin of a patient to deliver the electrical energy.

The electrodes are arranged in regular or irregular patterns. The sizes, number of electrodes, and electrode pattern are determined by the location, depth, and geometry of the target which is either an implanted device receiving electrical power or a biological target receiving stimulation. These important parameters are determined by finite element methods. The present invention, however, is not limited to any particular pattern, arrangement, or configuration of electrodes, or any particular antenna configuration or design. In addition, the present invention is not limited to any particular number of electrodes that are contained within the array. The number of electrodes will vary.

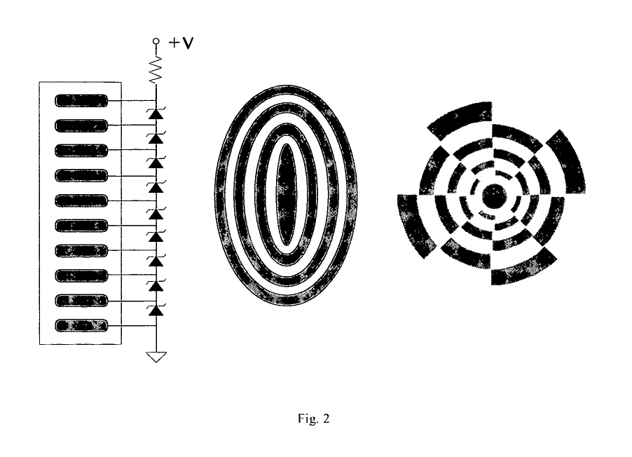

FIG. 2 presents three examples of electrode arrangements that may be used in accordance with the present invention. In FIG. 2, the electrodes are shown in gray. The left panel in FIG. 2 shows a number of electrodes which are generally linearly arranged. The electrodes may be made of metal or other conducting material, arranged in parallel and placed on an insulating, flexible substrate (the rectangle). Each electrode may have its own power source for delivery of voltage. Alternatively, there may be one power source and the input voltage, +V, may applied to an array of zener diodes through a current limiting resistor. When the voltages across the diodes are equal, the antenna has a linear source distribution resembling the structure of the weaponry organ of the electric eel.

The middle panel in FIG. 2 shows another design where generally oval-shaped electrodes are arranged in a concentric fashion on a flexible substrate. Each electrode may have its own power source. When affixed to the skin, the rings of electrodes are applied with different voltages forming an axially symmetrical electrode field within the human body. The right panel in FIG. 2 illustrates a more complex design where each electrode can be individually activated through its unique power source. The activation signals are programmed to control the direction, depth, and/or duration of electrical energy delivery.

### EXAMPLES

In practice, it is difficult and tedious to obtain a map of electric field distribution within a volume conductor using point-by-point measurements. Computational evaluation provides a powerful alternative approach to this evaluation problem. Volume conduction obeys the physical law of electrostatics. The potential produced by a current source is given by the Poisson's equation: σ∇²φ=∇J, where ∇ is the gradient operator (a vector), φ denotes the potential (a scalar), J represents the impressed current density (or primary current density, a vector) which exists only within the region of the source, and σ is the conductivity which is assumed to be a scalar constant within a specified region of the volume conductor. Since φ is only of interest outside the small region where the primary current is present, the right side of Poisson's equation becomes zero within the region of interest. With these simplifications, Poisson's Equation becomes Laplace's equation σ∇²φ=0.

Laplace's equation can be solved numerically by using the finite element method (FEM) in which the original continuous solution over the interested domain are approximated by a set of algebraic equations on a set of elementary building blocks called elements. These algebraic equations are solved numerically. In order to obtain a solution specific to the simulation problem, a set of boundary conditions must be specified between the volume conductor layers with different conductivity values and on the outside surface of the volume conductor.

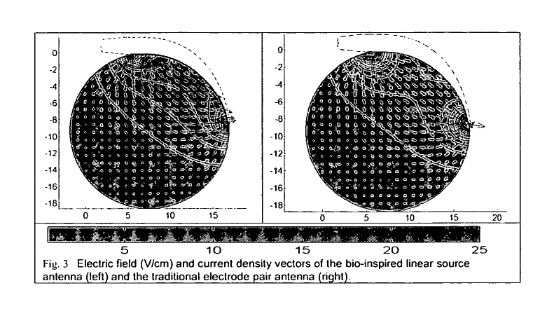

In order to design an antenna simulating the weaponry organ of electric fish, it was assumed that voltage on the antenna varies continuously. Although this is unrealistic in practice, it provides insight into practical antenna designs. FIG. 3 shows the potential gradient and current density within a conductive circle modeling a cross section of the human head. The result of the continuous linear source distribution antenna is shown in the left panel and that of the traditional electrode pair antenna is shown in the right panel. In both cases, the total current flowing through the volume conductor is identical. Comparing the current flow lines (arrows) in the upper right section in both panels, it is clear that a higher energy density is induced by the fish-like linear source antenna within a target region of the brain.

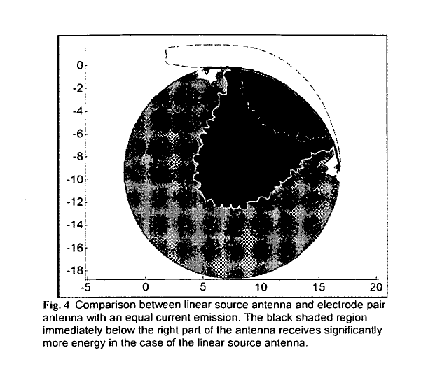

Measurements were taken of the current distributions induced by the linear source antenna, c₁, and the electrode pair antenna, c₂, and calculations were made of the relative percentage, ‘r, r=(c₁−c₂ )/c₂×100%, at each location within the simulated domain. FIG. 4 shows the results where the black shade, dark shade, light shade, and white shade, respectively, represent r≧25%, 0≦r<25%, −25%≦r<25%, and r<−25%. It can be observed that the linear source antenna delivers significantly more energy to a region immediately below the active portion of the antenna. It can also be observed, since the new antenna emits currents spanning a region rather that two current emitting poles, the problematic effects of local heating and undesired stimulation to excitable tissues are significantly reduced.

With the results of the continuous linear source antenna, the practical designs shown in FIG. 2 were evaluated. In this case, it was assumed that the head is the volume conduction medium and the simulation is performed in a cross section. Without loss of generality, it was also assumed that of the radius of the head is one unit and, for the new antenna, the shorter side of each electrode in the left panel in FIG. 2 is in the direction perpendicular to the paper (toward the observer). Although this modeling simulates the design in the left panel of FIG. 2, it also approximates the designs in the middle and right panels of FIG. 2, considering a selected ray drawn from the center of the two antenna designs. The voltage/current distribution along this ray is similar to that along the central axis of the left-most design.

The performance of the linear source antenna was compared with the traditional electrode pair antenna. In the simulation, the antenna occupies one-quarter of the circumference of the circle. The size of each strip (the short size of the electrodes in the left panel of FIG. 2) is identical and the width of the gap between strips is the same as the strip. To compare with the two electrode case, a positive (100V) and negative electrode (0V) pair (each with the same size as a strip) is placed on the head ¼ of the circumference apart, and variations of voltages assigned to the electrode vary linearly, i.e., for a linear strip electrode containing {1, 2, . . . , n} strips, the i-th strip is set to voltage [V/(n−1)]*(i−1), where V is an numerically determined positive voltage calculated to ensure that the maximum energy density is the same for the two electrode types. This base of comparison, which differs from that in the previous case, represents a practical constraint on maximally allowed energy dissipation within biological tissue.

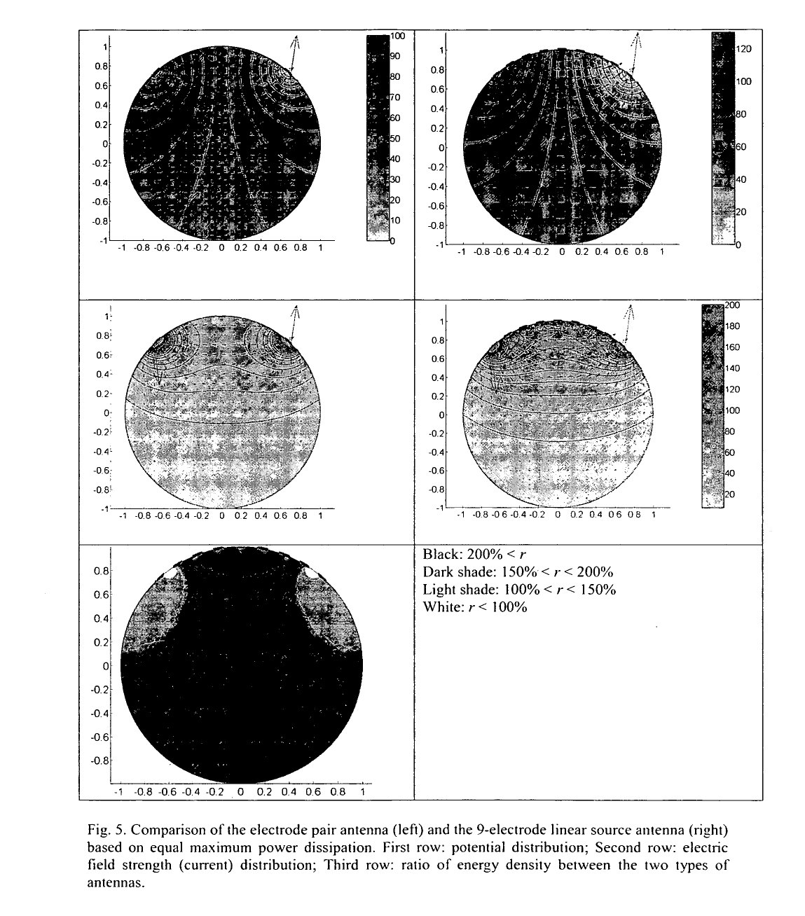

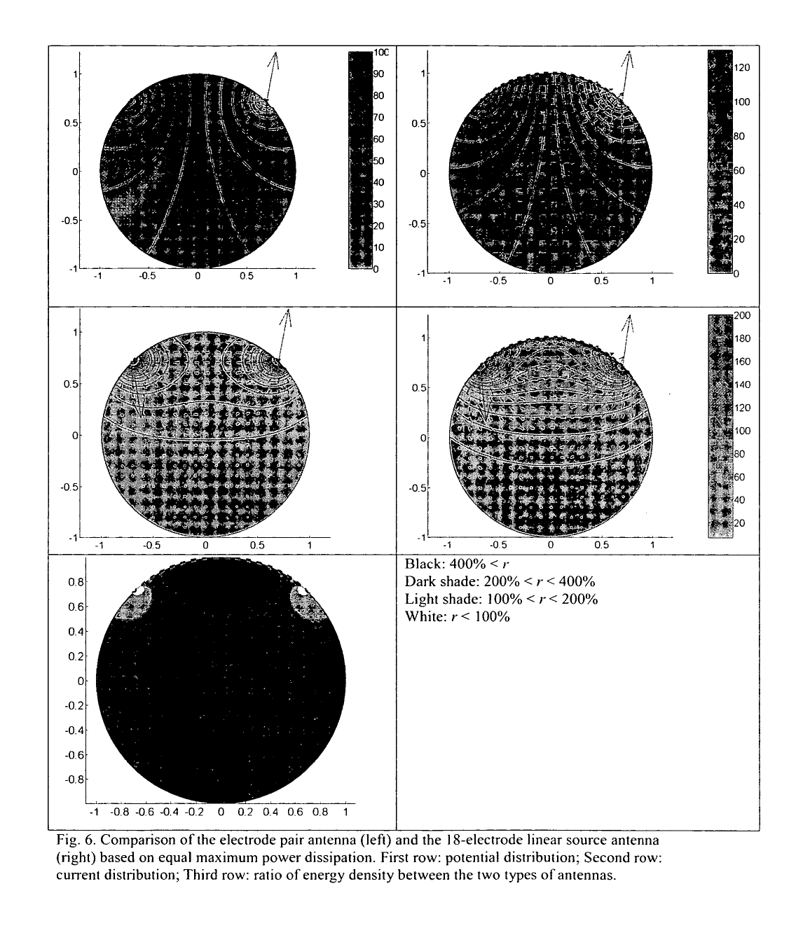

As described previously, the energy density, P, within the volume conductor is calculated from Joule's Law: P=σE·E, where σ is assumed, without loss of generality, to be unity. The simulation results for both the linear source antenna and the electrode pair antenna are shown in FIGS. 5 and 6. The linear strip antennas in FIGS. 5 and 6 contain 9 and 18 strips, respectively. The first two rows in each figure show, respectively, the potential (in Volts) and electric field strength (current) distributions (in V/m or A/m). In the field strength distribution image, the maximum field strength is capped at 200V/m for ease of comparison and clarity. The black and white image in the third row of each figure represents a ratio, r, of the energy density P between the two antenna types, with r=Pₗᵢₙₑₐᵣ/Pₚₐᵢᵣ.

FIGS. 5 and 6 show striking improvements in energy delivery by the linear source antenna over the electrode pair antenna. It can be clearly observed that the linear source antenna significantly increases P at the target location at least twice (for the 9-electrode case) and 4 times (for the 18-electrode case). It can also be observed that, in theory, more electrodes provide better performance. However, the number of electrodes is constrained by practical factors, such as the electrode impedance and the complexity of the control circuit.

Whereas particular embodiments of this invention have been described above for purposes of illustration, it will be evident to those skilled in the art that numerous variations of the details of the present invention may be made without departing from the invention as defined in the appended claims.

What is claimed is:

1. An antenna for delivering electrical energy to a target site in a patient's body, the antenna comprising an array of electrodes, wherein the electrodes are structured and arranged to receive voltage and work collaboratively to transmit electrical energy to the target site.

2. The antenna of claim 1, wherein each electrode is supplied with a unique voltage capable of producing an electrical current within a patient's body.

3. The antenna of claim 2, wherein the unique voltage supplied to each electrode activates transmission of responsive electrical energy from the array of electrodes to the target site.

4. The antenna of claim 2, wherein the voltage delivered to each electrode is predetermined to control at least one of direction, depth, and duration of the electrical energy transmitted from the array of electrodes.

5. The antenna of claim 2, wherein the unique voltage is selected from the group consisting of a positive voltage, a negative voltage, and zero voltage.

6. The antenna of claim 1, wherein the electrodes are generally linearly arranged.

7. The antenna of claim 6, wherein the electrodes are connected in series and a single power source delivers voltage through a current limiting resistor.

8. The antenna of claim 1, wherein the array of electrodes comprises a plurality of concentric, generally oval-shaped electrodes.

9. The antenna of claim 1, wherein ionic fluid in the patient's body conducts the electrical energy from the array of electrodes to the target site.

10. The antenna of claim 1, wherein the antenna optimizes energy density at the target site for a given antenna configuration.

11. The antenna of claim 1, wherein the antenna minimizes energy density at the array of electrodes for a given antenna configuration.

12. The antenna of claim 1, wherein the array of electrodes is affixed to a patient's skin.

13. The antenna of claim 1, wherein the target site is a medical device implanted in the patient's body.

14. The antenna of claim 13, wherein the electrical energy from the array of electrodes charges a power source within the medical device.

15. The antenna of claim 13, wherein the electrical energy from the array of electrodes is used to operate the medical device.

16. The antenna of claim 1, wherein the target site is a biological target.

17. The antenna of claim 16, wherein the electrical energy stimulates the target site.

18. The antenna of claim 1, wherein the target site is selected from the group consisting of tissue, muscle, and nerve.

19. A method for delivering electrical energy to a target site in a patient's body, the method comprising:
providing an array of electrodes, wherein the electrodes are structured and arranged to receive voltage and work collaboratively to transmit electrical energy to the target site; and
delivering a unique voltage to each electrode, wherein the unique voltage activates transmission of responsive electrical energy from the array of electrodes to the target site.

20. The method of claim 19, further comprising predetermining the unique voltage that is delivered to each electrode to control at least one of direction, depth, and duration of the electrical energy transmitted from the array of electrodes.

21. The method of claim 19, wherein each electrode has a power source capable of delivering the unique voltage.

22. The method of claim 19, wherein the unique voltage is selected from the group consisting of a positive voltage, a negative voltage, and zero voltage.

23. The method of claim 19, wherein the electrodes are generally linearly arranged.

24. The method of claim 23, wherein the electrodes are connected in series and a single power source delivers voltage through a current limiting resistor.

25. The method of claim 19, wherein the array of electrodes comprises a plurality of concentric, generally oval-shaped electrodes.

26. The method of claim 19, wherein ionic fluid in the patient's body conducts the electrical energy from the array of electrodes to the target site.

27. The method of claim 19, wherein the antenna optimizes energy density at the target site for a given antenna configuration.

28. The method of claim 19, wherein the antenna minimizes energy density at the array of electrodes for a given antenna configuration.

29. The method of claim 19, further comprising affixing the array of electrodes to a patient's skin.

30. The method of claim 19, wherein the target site is a medical device implanted in the patient's body.

31. The method of claim 30, wherein the electrical energy from the array of electrodes charges a power source within the medical device.

32. The method of claim 30, wherein the electrical energy from the array of electrodes is used to operate the medical device.

33. The method of claim 19, wherein the target site is a biological target.

34. The method of claim 33, wherein the electrical energy stimulates the target site.

35. The method of claim 19, wherein the target site is selected from the group consisting of tissue, muscle, and nerve.
